(19) United States
(12) Patent Application Publication
(10) Pub. No.: US 2012/0122447 A1
(43) Pub. Date: May 17, 2012

(54) System and Method for On-Demand Diagnostics of a Device Utilizing Secure Data to Interact Wirelessly with One or More Third Party Systems

(76) Inventors: Michael Craft, Carlsbad, CA (US); David Brudnicki, Duvall, WA (US); Hans Reisgies, San Jose, CA (US); Andrew Weinstein, San Francisco, CA (US)

(21) Appl. No.: 13/279,194

(22) Filed: Oct. 21, 2011

Related U.S. Application Data
(60) Provisional application No. 61/414,857, filed on Nov. 17, 2010.

(51) Int. Cl. H04W 24/00

(52) U.S. Cl. 455/423

(57) ABSTRACT

A system and method for remotely providing an end user with a solution to a failure in a mobile transaction is disclosed. The system includes a portable communication device having a diagnostics agent configured to transmit the communication device's unique identification number and present status over a mobile network. The system further includes a retailer subsystem in short proximity communication with the communication device, and a remote system management back end in wireless communication with both the communication devices and the retailer subsystem. The system management back end has a diagnostics management system configured to receive failure data from the portable communication device, and to determine a solution based on the failure data. The system also includes a mobile network in communication with the system management back end, via which the solution is wirelessly transmitted to the end user.

This application claims priority from U.S. Provisional Patent Application No. 61/414,857, filed on Nov. 17, 2010.

### TECHNICAL FIELD

The present invention relates generally to the use of secure data to complete a wireless transaction, and more particularly to a system and method for diagnosing problems with a device utilizing such secure data to interact with a third party system including the interconnection between the device and system.

### BACKGROUND

Wireless transactions using RFID-based proximity cards are fairly common place. For instance, many workers use RFID keycards to gain access to their workplace and drivers use RFID passes to pay tolls at highway speeds. RFID, which stands for radio-frequency identification, uses electromagnetic waves to exchange data between a terminal and some object for the purpose of identification. More recently, companies have been trying to use RFIDs supported by cellular telephones to implement an electronic payment product (i.e. credit and/or debit card). In such a wireless transaction, various transactional data is required to be transmitted by and among various servers, entities, etc, including amount of the transaction, a unique transaction identification number (“transaction ID”), a unique retailer identification number (“retailer ID”), retailer business category (e.g., retail, restaurant, entertainment, travel, electronics, etc), and an encrypted card identification number corresponding to the user's credit card or other banking account identification (“bank ID”). This data is collectively referred to as “transaction data.” However, basic RFID technology raises a number of security concerns that have prompted modifications of the basic technology. Still, wide spread adoption of RFID as a mechanism for electronic payments has been slow.

Near Field Communication (NFC) is another technology that uses electromagnetic waves to exchange data. NFC waves are only transmitted over a short-range (on the order of a few inches) and at high-frequencies. NFC devices are already being used to make payments at point of sale (“POS”) devices. NFC is an open standard (see, e.g. ISO/IEC 18092) specifying modulation schemes, coding, transfer speeds and RF interface. There has been wider adoption of NFC as a communication platform because it provides better security for financial transactions and access control. Other short distance communication protocols are known and may gain acceptance for use in supporting financial transactions and access control.

Regardless of the wireless communication protocol selected, there are bound to be operational errors within: the devices on which the protocol is implemented (called “wireless wallets” in the present specification); communications between the wireless wallet and local host devices (e.g. point of sale terminals, keycard access control terminals); within the local host devices; within any server-side equipment that must interact with the local host devices (e.g. for confirmation or approval); and/or within communications between the wireless wallet, its mobile network and beyond. For instance, a consumer may have trouble completing a purchase using the “credit card” embedded in his smartphone in a big-box retail store at the point of sale because of one or more problems with (1) the NFC connection between the consumer's phone and the point of sale device; (2) the secure data is corrupt on the consumer's smartphone; (3) the consumer's electronic wallet account has been disabled by the card issuer; (4) the point of sale device has outdated NFC communication software; etc.

A problem arises in that no single company is presently responsible for coordinating the troubleshooting of failed electronic wallet transactions. As such, the consumer may have a difficult time determining which—if any—of the foregoing potential problems is preventing the desired electronic wallet transaction. Thus, the consumer may stop using the electronic wallet or may not be able to complete a transaction with that particular retailer leading the consumer to try to consummate a similar transaction with a competitor.

A related problem arises in that diagnostic software that can facilitate diagnosis of the problem has not been developed for deployment and use on smartphones or similar devices.

Accordingly, the present invention seeks to provide one or more solutions to the foregoing problems and related problems as would be understood by those of ordinary skill in the art having the present specification before them. These and other objects and advantages of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

### SUMMARY OF THE INVENTION

The invention is, in part, a system for remotely providing an end user with a solution to a failure in a mobile transaction. The system includes a system management back end in operable communication with a portable communication device having a unique identification number and a status, a central diagnostics management system configured to receive the unique identification number, the status, and failure data from the portable communication device, and to determine a solution based on one or more of the unique identification number, the status, and the failure data; wherein the system management back end is configured to wirelessly communicate the solution to the end user via the mobile network.

### BRIEF DESCRIPTION OF THE DRAWINGS

For a better understanding of the present disclosure, non-limiting and non-exhaustive embodiments are described in reference to the following drawings. In the drawings, like reference numerals refer to like parts through all the various figures unless otherwise specified.

FIG. 1a illustrates the operable interconnections between the end user's portable communication device and various subsystems, including the system management back end;

FIG. 1b illustrates the diagnostic agent installed in the end user's portable communication device asking whether she would like diagnostics performed following a failed attempt to use her device to conduct a secure payment transaction at a point of sale.

FIG. 2 is a block diagram illustrating some of the logical blocks within a portable communication device that may be relevant to the present system.

FIG. 3 is a block diagram illustrating the logical blocks within the system management back end server.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

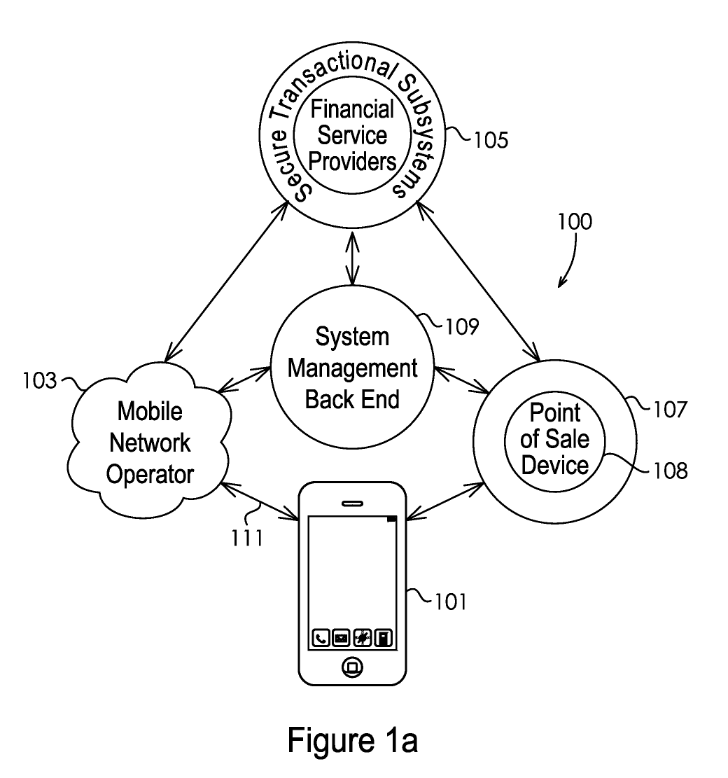

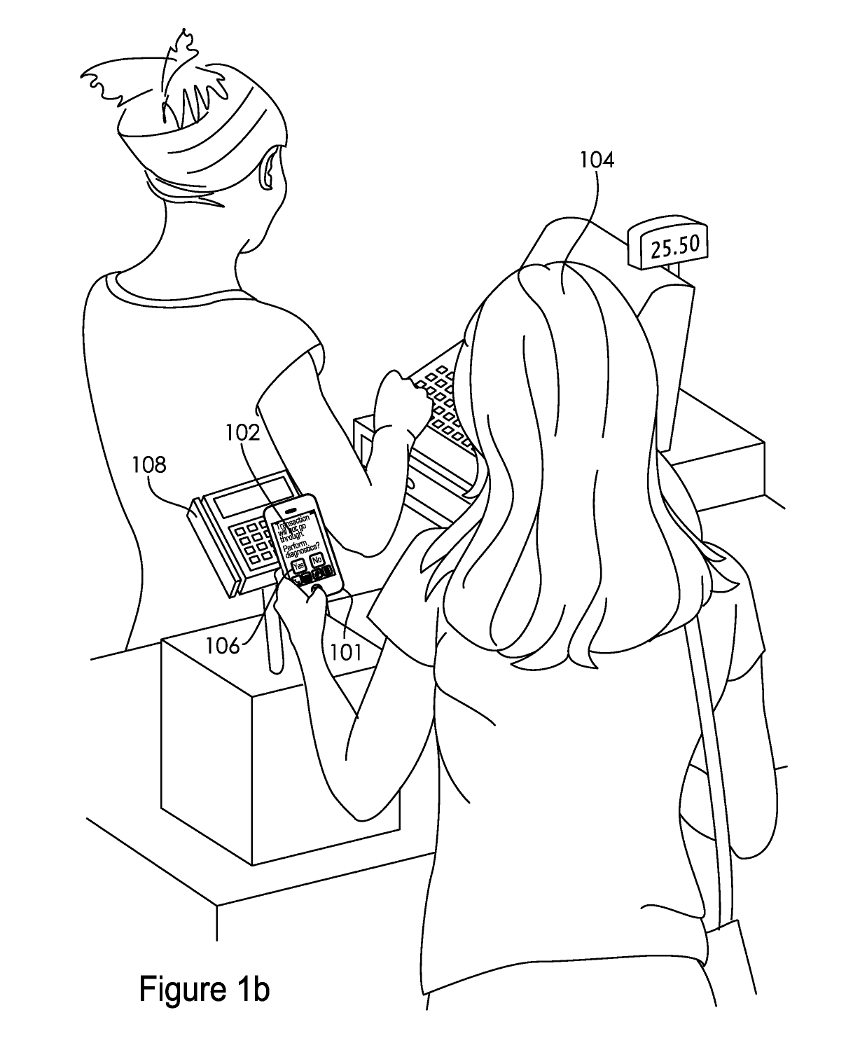

FIG. 1A illustrates the overall system 100 in accordance with one embodiment of the invention, showing operable interconnections between an end user's portable communication device 101 and various subsystems, including a system management back end 109. FIG. 1B illustrates one example implementation of an aspect of the system 100 in use, showing a diagnostic agent installed in the end user's portable communication device 101 asking whether she would like diagnostics performed following a failed attempt to use her device to conduct a secure payment transaction at a point of sale 108.

Below each component of the overall system 100 will be described in greater detail, as will the overall operation and functionality of the claimed system and method.

### Portable Communication Devices

The present invention provides a system and method that can be utilized with a variety of different portable communication devices 101, including but not limited to PDA's, cellular phones, smart phones, laptops, tablet computers, and other mobile devices that include cellular voice and data service as well as preferable access to consumer downloadable applications. One such portable communication device 101 could be an iPhone, Motorola RAZR or DROID, however, the present invention is preferably platform and device independent. For example, the portable communication device technology platform may be Microsoft Windows Mobile, Microsoft Windows Phone 7, Palm OS, RIM Blackberry OS, Apple OS, Android OS, Symbian, Java or any other technology platform. For purposes of this disclosure, the present invention has been generally described in accordance with features and interfaces that are optimized for a smart phone utilizing a generalized platform, although one skilled in the art would understand that all such features and interfaces may also be used and adapted for any other platform and/or device.

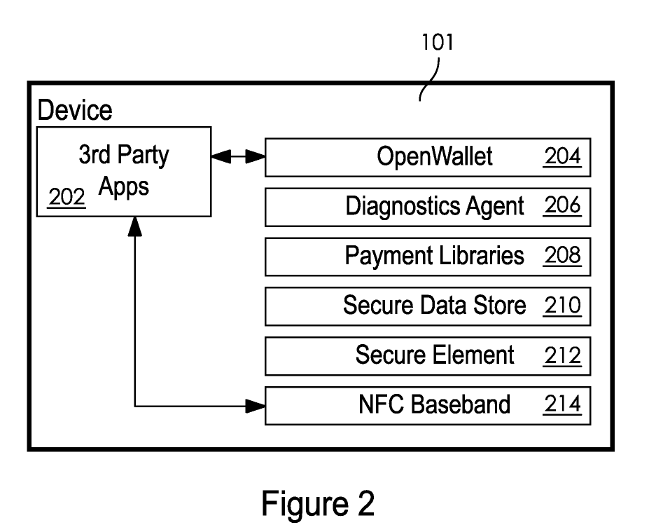

FIG. 2 is a block-diagram illustrating some of the logical blocks within a portable communication device in accordance with an embodiment of the present system 100. The portable communication device 101 includes one or more short proximity electromagnetic communication devices, such as an NFC, RFID, or Bluetooth transceiver. It is presently preferred to, use an NFC baseband 214 that is Compliant With NFC IP 1 standards (www.nfcforum.org), which provides standard functions like peer-to-peer data exchange, reader-writer mode (i.e. harvesting of information from RFID tags), and contactless card emulation (per the NFC IP 1 and ISO 14443 standards) when paired with a secure element 212 on the portable communication device 101 and presented in front of a “contactless payment reader” (see below at point of sale). As would be understood in the art by those having the present specification, figures, and claims before them, the NFC IP 1 standards are simply the presently preferred example, which could be exported—in whole or in part—for use in association with any other proximity communication standard. It is further preferred that the portable communication device 101 include an NFC/RFID antenna (conformed to NFC IP 1 and ISO 14443 standards) to enable near-field communications. However, as would be understood in the art NFC/RFID communications may be accomplished without an antenna, albeit over even shorter ranges and potential read problems.

As shown in FIG. 1A, the portable communication device 101 also includes a mobile network interface 111 to establish and manage wireless communications with a mobile network operator 103. The mobile network interface uses one or more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols to communicate with the mobile network of a mobile network operator. Accordingly, the mobile network interface may include as a transceiver, transceiving device, or network interface card (NIC). It is contemplated that the mobile network interface 111 and short proximity electromagnetic communication device could share a transceiver or transceiving device, as would be understood in the art by those having the present specification, figures, and claims before them.

The portable communication device 101 further includes a user interface 102 (see FIG. 1B) that provides some means for the consumer 104 to receive information as well as to input information or otherwise respond to the received information. As is presently understood (without intending to limit the present disclosure thereto) this user interface may include a microphone, an audio speaker, a haptic interface, a graphical display, and a keypad, keyboard, pointing device and/or touch screen. As would be understood in the art by those having the present specification, figures, and claims before them, the portable communication device 101 may further include a location transceiver that can determine the physical coordinates of device on the surface of the Earth typically as a function of its latitude, longitude and altitude. This location transceiver preferably uses GPS technology, so it may be referred to herein as a GPS transceiver, however, it should be understood that the location transceiver can additionally (or alternatively) employ other geo-positioning mechanisms, including, but not limited to, triangulation, assisted GPS (AGPS), E-OTD, CI, SAI, ETA, BSS or the like, to determine the physical location of the portable communication device 101 on the surface of the Earth.

The portable communication device 101 will, as is well known, also include a microprocessor and mass memory. The mass memory may include ROM, RAM as well as one or more removable memory cards. The mass memory provides storage for computer readable instructions and other data, including a basic input/output system (“BIOS”) and an operating system for controlling the operation of the portable communication device 101. The portable communication device 101 will also include a device identification memory dedicated to identify the device, such as a SIM card. As is generally understood, SIM cards contain the unique serial number of the device (ESN), an internationally unique number of the mobile user (IMSI), security authentication and ciphering information, temporary information related to the local network, a list of the services the user has access to and two passwords (PIN for usual use and PUK for unlocking). As would be understood in the art by those having the present specification, figures, and claims before them, other information may be maintained in the device identification memory depending upon the type of device, its primary network type, home mobile network operator, etc.

In the present invention each portable communication device 101 is thought to have two subsystems: (1) a “wireless subsystem” that enables communication and other data applications as has become commonplace with users of cellular telephones today, and (2) the “secure transactional subsystem” which may also be known as the “payment subsystem”. As illustrated in FIG. 2, it is contemplated that the secure transactional subsystem will preferably include a Secure Element 212, similar (if not identical) to that described as part of the Global Platform 2.1.X or 2.2 (www.globalplatform.org). The secure element 212 has been implemented as a specialized, separate physical memory used for industry common practice of storing payment card track data used with industry common point of sale; additionally, other secure credentials that can be stored in the secure element include employment badge credentials (enterprise access controls), hotel and other card-based access systems and transit credentials.

### Mobile Network Operator

Each of the portable communications devices 101 is connected to at least one mobile network operator 103. The mobile network operator 103 generally provides physical infrastructure that supports the wireless communication services, data applications and the secure transactional subsystem via a plurality of cell towers that communicate with a plurality of portable communication devices 101 within each cell tower's associated cell. In turn, the cell towers may be in operable communication with the logical network of the mobile network operator 103, POTS, and the Internet to convey the communications and data within the mobile network operator's own logical network as well as to external networks including those of other mobile network operators 103. The mobile network operators 103 generally provide support for one or more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols to communicate with the portable communication devices.

### Retail Subsystem

Standard at merchants today is an Internet Protocol connected payment system that allows for transaction processing of debit, credit, prepay and gift products of banks and merchant service providers, referred to herein as a “retail subsystem” 107. By swiping a magnetic stripe enabled card at the magnetic reader of a Point of Sale Terminal (also referred to as a point of sale device or generally as point of sale equipment) 108, the card data is transferred to the point of sale equipment 108 and used to confirm funds by the issuing bank. This point of sale equipment 108 of the retail subsystem 108 has begun to include contactless card readers as accessories that allow for the payment card data to be presented over an RE interface, in lieu of the magnetic reader. The data is transferred to the reader through the RE interface by the ISO 14443 standard and proprietary payment applications like PayPass and Paywave, which transmit the contactless card data from a card and in the future a mobile device that includes a Payment Subsystem.

As is well known, a retailer's point of sale device 108 may be connected to a network via a wireless or wired connection. This point of sale network may include the Internet in addition to local area networks (LANs), wide area networks (WANs), direct connections, such as through a universal serial bus (USB), port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, any communication method may be used that allows information to travel between the retail subsystem 107 and financial services providers of a secure transactional subsystem 105 for the purpose of validating, authorizing and ultimately capturing financial transactions at the point of sale 108 for payment via the secure transaction subsystem 105.

### Secure Transactional Subsystem

The system includes a secure transactional subsystem 105 made up of one or more financial services providers. The secure transactional subsystem 105 includes secure elements and associated device software for communication to management and provisioning systems as well as the customer facing interfaces for use and management of secure data 210 stored in the secure elements of the customer's portable communication device 101. Preferably the secure transactional subsystem 105 will conform, where appropriate, to an international standard, such as the standard defined in Global Platform 2.1.X or 2.2.

### System Management Back End

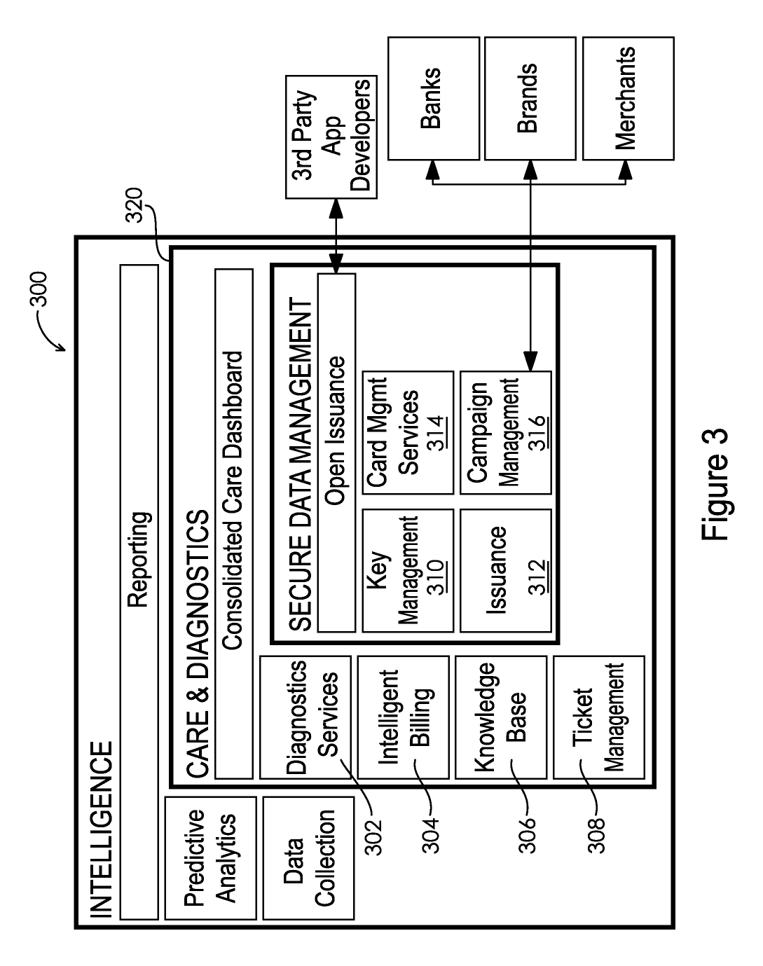

The system 100 of FIG. 1A further includes a system management back end 109. As shown in FIG. 1A, the system management back end 109 is connected to the retail subsystem 107, the secure transactional subsystem 105 and to a plurality of portable communication devices 101 via the infrastructure of at least one mobile network operator 103. The system management back end 109 has a server (300 in FIG. 3) operably communicating with one or more client devices (302-316 in FIG. 3). The server, which is shown in greater detail in FIG. 3, is also in operable communication with the retailer subsystem 107, secure transactional subsystem 105, and one or more portable communication devices 101. The communications include data and voice channels. Any type of voice channel may be used in association with the present invention, including but not limited to VoIP.

The server 300 may comprise one or more general-purpose computers that implement the procedures and functions needed to run the system back office in serial or in parallel on the same computer or across a local or wide area network distributed on a plurality of computers and may even be located “in the cloud” (subject to the provision of sufficient security). The computer(s) comprising the server may be controlled by Linux, Windows®, Windows CE, Unix, or a Java® based operating system, to name a few. The system management back end server 109 is operably associated with mass memory that stores program code and data. Data may include one or more databases, text, spreadsheet, folder, file, or the like, that may be configured to maintain and store a knowledge base, user identifiers (ESN, IMSI, PIN, telephone number, email/IM address, billing information, or the like).

The system management back end server 300 supports a care and diagnostics management system 320 to provide call traffic connectivity and distribution across the client devices 302-316 in the customer care center. In a preferred approach using VoIP voice channel connectivity, the care and diagnostics management system 320 is a contact/case management system distributed by Contactual Inc. of Redwood City, Calif. The Contactual Inc. system is a standard CRM system for a VoIP-based customer care call center that also provides flexibility to handle care issues with simultaneous payments and cellular-related care concerns. As would be understood by one of ordinary skill in the art having the present specification, drawings and claims before them, other case management systems may be utilized within the present invention such as Salesforce (salesforce.com inc. of San Francisco, Calif.) and Novo (Novo Solutions, Inc. of Virginia Beach, Va.).

Each client computer 302-316 associated with the system management back end 109 server has a network interface device, graphical user interface, and voice communication capabilities that match the voice channel(s) supported by the client care center server, such as VoIP. Each client computer can request status of both the cellular and secure transactional subsystems of a portable communication device. This status may include the contents of the soft memory and core performance of portable communication device, the NFC components: baseband, NFC antenna, secure element status and identification.

### On Demand Diagnostics

As shown in FIG. 1B, the consumer 104 has a portable communication device 101 enabled with a secure payment subsystem and has made or has tried to make a payment at a physical retailer's Point of Sale device 108 (described above), which has failed. As shown on the video display 102 of the portable communication device, the resident diagnostic agent (206 in FIG. 2) has launched due to the failed transaction. As would be understood by those of ordinary skill in the art having the present specification, drawings, and claims before them, the use or the failed use of a secure subsystem in a portable communication device may similarly occur (and be similarly diagnosed) in a variety of other transactional settings, including but not limited to, loyalty transaction, hotel key card provisioning, transit ticket, or any other environment similar to the point of sale described above that has a reader that initiates a secure data transfer between a third party subsystem requiring information from the portable communication device toward securing approval of a next step, such as the purchase contemplated in the example of FIG. 2 or the opening of a hotel room.

The resident diagnostic agent 206 is downloaded onto the portable communication device 101 to assist in determining the reason(s) for the failed transaction. In the case of a purchase at a physical point of sale 108 using a wireless wallet the failure may be caused by problems with the retail subsystem, the financial service subsystem, a physical problem with the portable communication device or the RF link established between the portable communication device and the point of sale device or the link established between the portable communication device and the mobile network operator. As is presently understood, the retailer, the financial service provider (e.g. card issuer) and mobile network operator are usually three different entities and in some cases those entities may be in direct competition with one another for all or part of a consumer's business. As a result, the entities are unable to cooperate sufficiently to rectify problems with any individual transaction, especially in real time.

As shown in FIG. 1B, the consumer 104 may initiate a diagnostic session by manually indicating that a diagnostic session should commence. In particular, FIG. 1B shows “YES” and “NO” soft buttons 106 displayed on the touch screen 102 of the illustrated portable communication device 101. However, as would be understood by those of ordinary skill in the art having the present specification, drawings, and claims before them, consumer activation may be accomplished using a variety of user interactive techniques, all of which are contemplated by the present invention. If the consumer desires help with respect to the failed transaction, she may activate the local diagnostics agent 206 by opening a “help” screen from the diagnostics agent 206. The consumer may select a “Help Me” function, prompting the diagnostics agent 206 to (i) gather and encrypt the error condition/code as well as status information from the secure payment subsystem, the wireless subsystem (e.g. the current geo-coordinates of the portable communication device (i.e. which store the secure payment device is in), date/time, MSISDN, IMSI, UCC ID, Secure Element ID number, Card ID number, battery life status, device model number, mobile operating system, firmware version) and/or the system management back end application, and (ii) determine the most appropriate channel for transmitting that data (e.g. SMS, MMS, email, HTTP, etc.) preferably in a proprietary format to the system management back end.

Upon receipt of the data into the care and diagnostics system 320 of the system management back end 109, the system generates an “Event Record”. The care and diagnostics system 320 decodes and automatically uses the received data to generate, via a ticket management client device 308 a new “Care Ticket”. Preferably, the system management back end 109 will send the consumer 104 on the portable communication device 101, via the most appropriate communication channel, the estimated time before a “Care Agent” will call the consumer and/or recommend self-help resolutions. Where the portable communication device 101 has a camera (as can be gleaned from the model number data sent by the diagnostic device), the system may also prompt the consumer via a message to take an image of the point of sale device using the on-device camera. It is preferred for the diagnostics agent 206 to automatically select the best on-device camera settings to capture and transmit the image via the most appropriate channel. Upon receipt of the image, the system may add the image to the “Care Ticket” that has already been established by the ticket management device 308 for the event, and/or utilize pre-saved Point of Sale imagery to compare and auto-recognize the point of sale where the transaction was Made or attempted by the consumer. The care and diagnostics platform 320 of the system management back end 109 also obtains data from the secure payment subsystem 105, mobile network operator subsystem 103, and the retailer subsystem 107 regarding the failed secure transaction.

After the diagnostic agent 206 automatically contacts the system management back end 109, the consumer may also contact the system management back end 109 via the communication channel on their portable communication device 101. Because the diagnostic agent 206 sent information regarding the portable communication device 101, the system will preferably be able to automatically correlate the open Care Ticket generated by the ticket management device 308 with the portable communication device 101.

Once the information that can be gathered about the failure event has been gathered, a human care agent would review the care ticket via the care management software and contact the consumer on her portable communication device 101. Once contact is established, the human care agent will guide the consumer through the deductive resolution process using the information received in conjunction with the system management back end knowledge database 306. The deductive resolution process continues between the care agent and the consumer until the issue is resolved. Upon resolution of the issue, the Care Ticket as well as a Knowledge Library generated by the knowledge database 306 are updated based on the information gathered in this call.

In some instances the consumer may initiate a help session via a voice call by dialing a care help number without first initiating the diagnostics agent 206. Perhaps the consumer wants to speak with a live agent first or perhaps the consumer is not comfortable using the diagnostic agent 206. The call may directly connect or be rerouted to a live agent via the system. Upon receipt of the call into the care and diagnostics platform 320, the system generates an “Event Record” and “Care Ticket”. Based on the caller identification number associated with the telephone call, the system management back end 109 would then initiate communications with the diagnostics agent 206 installed on the consumer's portable communication device 101 using the appropriate communication channel (e.g. e.g. SMS, MMS, HTTP, Secure Sockets, and email). In an example, where the portable communication device 101 is GSM 3G based, there may also be support for simultaneous voice and data sessions available particularly from certain mobile network operators 103. In the case of a CDMA 3G based device, the users could receive a message while they are in voice session since simultaneous voice and data sessions are not supported (Verizon). The diagnostic agent 206 will gather the same information described in the foregoing paragraph for use in the system management back end 109 in diagnosing the failure. Of course, in the event that communications cannot be opened with the diagnostics agent 206 on the consumer's portable communication device 101, the care agent may direct the consumer to open the diagnostic agent manually and/or navigate to the “Help” screen of the diagnostic agent and select the “Help Me” function manually, which should result in the gathering and transmission of data to the system management back end 109, as discussed above. The call would follow along much the same lines as the call initiated by the diagnostic agent 206.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A system for remotely providing an end user with a solution to a failure in a mobile transaction, the system comprising:
a system management back end in operable communication with a portable communication device having a unique identification number and a status,
a central diagnostics management system configured to receive the unique identification number, the status, and failure data from the portable communication device, and to determine a solution based on one or more of the unique identification number, the status, and the failure data; wherein
the system management back end is configured to wirelessly communicate the solution to the end user via the mobile network.

2. The system according to claim 1 wherein the portable communication device further includes a display screen for displaying the solution to the end user.

3. The system according to claim 1 wherein the diagnostics management system further includes a client device having a graphical user interface for use by a customer care agent.

4. The system according to claim 3 further comprising a voice communication channel between the client device and the portable communication device for communicating voice information relating to the failure.

5. The system according to claim 1 wherein the diagnostics management system further comprises a ticket management device configured to decode one or more of the state and the failure data, and to generate a care ticket.

6. The system according to claim 5 wherein the failure data includes image data.

7. The system according to claim 5 wherein the failure data includes the unique identification number and the present status.

8. The system according to claim 1 wherein the portable communication device includes a transceiver in communication with a point of sale device for carrying out the mobile transaction, wherein the transceiver is selected from the group consisting of a near field communication device, a radio-frequency identification device and a Bluetooth device.

9. A method for remotely providing an end user of a portable communication device with a solution to a failure in a mobile transaction, wherein the portable communication device includes a unique identification number and a diagnostics agent configured to transmit the unique identification number and a present status of the portable communication device, the method comprising:
receiving failure data from the portable communication device by a remote system management back end;
determining a solution at the remote system management back end based on the failure data; and
transmitting the solution to the end user via a mobile network.

10. The method according to claim 9 further comprising establishing a voice communication channel between the remote system management back end and the portable communication device for communicating voice information relating to the failure.

11. The method of claim 9 further comprising decoding the failure data and generating a corresponding care ticket.

12. The method according to claim 11 wherein the failure data includes image data.
